(19) United States
(12) Patent Application Publication
(10) Pub. No.: US 2007/0028273 A1
(43) Pub. Date: Feb. 1, 2007

(54) Wireless satellite transverser with secured wireless infrastructure/ad-hoc modes

(76) Inventor: Farouk M. Zanaty, Palm Bay, FL (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/191,011

(22) Filed: Jul. 28, 2005

(51) Int. Cl. H04N 7/20

(52) U.S. Cl. 725/63; 725/68

(57) ABSTRACT

A wireless satellite transverser that transceives wireless communication data from and to a satellite dish in enterprise and home applications. The wireless satellite transverser works in both wireless Infrastructure and Ad-hoc modes to communicate with wireless satellite set top box transversers connecting to the same dish or multiple dishes in a virtual wireless Local Network.

### BACKGROUND OF THE INVENTION

In general, satellite television includes a satellite dish in enterprise and home applications that receives a signal from a direct broadcast satellite (DBS) provider and then transmits the DBS signal to a receiver through a cable. Presently several hundred channels of digital programming are transmitted from the DBS provider to enterprise and home subscribers. Satellite television has continued to grow in popularity because of the high quality signal and programming choices.

Each designated service area that has a TV includes a set-top-box (STB) or receiver that takes the DBS signal from the cable outlet in the wall, decodes the DBS signal, and provides the decoded DBS signal to the TV for viewing. Satellite TV interfaces with the existing cable wiring to distribute the DBS signal from the satellite dish to the STB. In most older buildings and homes cable television outlets were not wired for multiple room applications. However, adding new outlets for a TV in a new room or moving the TV require adding new cable outlets or moving the existing cable outlets. In order to serve new locations running additional cables through existing walls is required. This often causes damage and requires patching and painting and often the services of a qualified electrician to wire each new outlet for a TV. Also, in old buildings, the cost of asbestos cleanup or removal may make wiring new cable outlets or move existing cable outlets not feasible.

Accordingly, there is a need to provide a wireless interface technique and means installed in the satellite dish and the set-top-boxes (STBs) to comply with wireless transmission needs as required by the IEEE 802.11(a), (b) and/or (g) standards for a wireless local area network to enable flexible distribution of DBS signals to different TV locations within the designated service area such as a home or an office.

### SUMMARY OF THE INVENTION

Various aspects and example embodiments of the present invention advantageously provide computer controlled wireless interface techniques for communication between a direct broadcast satellite dish and at least one display device such as a television.

In accordance with an aspect of the present invention, a satellite television entertainment system, comprising: a satellite dish to receive satellite television programming data; at least one set top box wireless transverser to wirelessly receive the satellite television programming data and format the satellite television programming data for display on a television; and a low noise block wireless transverser coupled with the satellite dish to wirelessly transmit the satellite television programming to the at least one set top box wireless transverser is provided. Thus, satellite television programming may be distributed wirelessly without the need to run cables in a building.

According to an aspect of the present invention, the low noise block wireless transverser configures data streams of different groups of individual channels from among all channels corresponding to the satellite television programming data such that each of the data streams of the different groups are wirelessly transmitted to a different one of the at least one set top box wireless transverser. Alternatively, the data streams of different groups of individual channels may be multiplexed and the resultant combined stream is transmitted from the low noise block wireless transverser to a set top box wireless transverser. The multiplexed stream will be de-multiplexed at the set top box wireless transverser. In an example embodiment, the low noise block wireless transverser serves as a wireless access point and the at least one set top box wireless transverser serves as a client device communicating with the low noise block wireless transverser according to wireless transmission standards specified by IEEE 802.11(a), (b) and/or (g). The set top box wireless transverser is configured to transmit the satellite television programming data and/or audio/visual (AV) signals wirelessly to another set top box wireless transverser.

In accordance with an aspect of the present invention, a system, comprising: a plurality of wireless transverser clients to wirelessly receive broadcast data corresponding to a selected set of television channels and format the programming data for display on a television;

and at least one low noise block wireless transverser to receive satellite programming data and to serve as an access point for a wireless network distribute the broadcast data to the plurality of wireless transverser clients, wherein the at least one low noise block wireless transverser decodes the satellite programming data and selects and compresses the broadcast data from the satellite programming data for distribution is provided.

According to an aspect of the present invention, the at least one low noise block wireless transverser comprises: an Encoder/Decoder configured to decode the satellite programming data and multiplex the broadcast data; and a wireless transmission unit configured to wirelessly transmit and receive data streams including the broadcast data, wherein the broadcast data is compressed by the Encoder/Decoder for wireless transmission to the plurality of set top box wireless transversers. The Encoder/Decoder of the low noise block wireless transverser selects and compresses different sets of the satellite programming data such that each of the different sets are wirelessly transmitted to a different one of the plurality of wireless transverser clients.

In accordance with an aspect of the present invention, a wireless satellite distribution device, comprising: a memory; a processor coupled with the memory; an Encoder/Decoder controlled by the processor to decode satellite programming data, buffered in the memory, and selectively compress a portion of the satellite programming data for distribution; and a wireless transmission unit configured to wirelessly distribute the portion of the satellite programming data according to control of the processor is provided.

According to an aspect of the present invention, the wireless satellite distribution device serves as a wireless access point communicates with a plurality of wireless client devices according to wireless transmission standards specified by IEEE 802.11(a), (b) and/or (g). The wireless satellite distribution device further comprises an encryptor/decryptor to encrypt the portion of the satellite programming data for distribution according to the wired equivalent privacy (WEP) protocol and decrypt all received data; and an authenticator to authenticate the received data using Wi-Fi Protection Access (WPA) or Wi-Fi Protection Access 2 (WPA2) along with Advanced Encryption Standard (AES) protocol.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an example of a Wireless Satellite Transverser System according to an embodiment of the present invention;

FIG. 2 illustrates an example Low Noise Block (LNB) Wireless Transverser according to an embodiment of the present invention;

FIG. 3 illustrates an example Set-Top-Box (STB) Wireless Transverser according to an embodiment of the present invention;

FIG. 4 illustrates an example interaction between the LNB Wireless Transverser and STB Wireless Transversers in an Infrastructure mode according to an embodiment of the present invention;

FIG. 5 illustrates an example interaction between STB Wireless Transversers in an Ad-hoc mode according to an embodiment of the present invention;

FIG. 6 is a flow diagram of an example process of generating and transmitting programming wirelessly from a satellite dish to a television according to an embodiment of the present invention;

FIG. 7 illustrates an example circuit diagram of an encryption module of the LNB Wireless Transverser and the STB Wireless Transverser according to an embodiment of the present invention; and

FIG. 8 illustrates an example data packet according to an embodiment of the present invention.

### DETAILED DESCRIPTION OF THE EMBODIMENTS

Before beginning a detailed description of the subject invention, mention of the following is in order. When appropriate, like reference numerals and characters may be used to designate identical, corresponding or similar components in differing figure drawings. Further, in the detailed description to follow, example sizes/values/ranges may be given, although the present invention is not limited to the same. The present invention is compatible with all audio/visual devices operable with an entertainment system, including, for example, DVD, CD VCR, and audio equipment. The present invention is able to interface with various types of networks such as an Integrated Systems Digital Network (ISDN), a Voice over IP (VolP) network, the Internet, and wireless digital communication services (e.g., wireless local area networks such as Wi-Fi networks, Bluetooth, ultra-wideband networks, and compatible wireless application protocols usable for wireless transmission as specified by IEEE 802.11(a), (b) and/or (g) standards, Bluetooth standards and other emerging wireless personal area networks such as Wi-Max in which service coverage areas can be extended up to 30 miles. However, for the sake of simplicity, discussions will concentrate mainly on exemplary use of a wireless communication between the components of a direct broadcast satellite television system, although the scope of the present invention is not limited thereto.

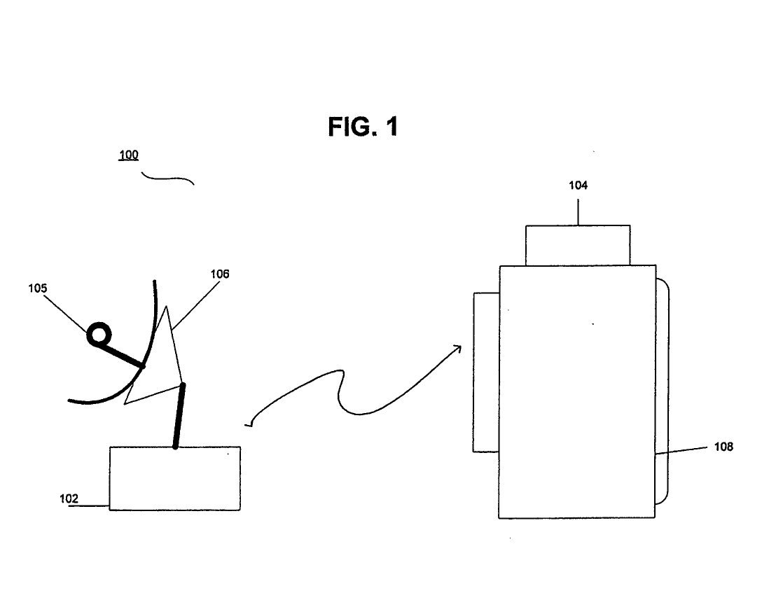

Attention now is directed to the drawings and particularly to FIG. 1, in which an example of a Wireless Satellite Transverser System according to an embodiment of the present invention is illustrated. As shown in FIG. 1, the Wireless Satellite Transverser System 100 comprises a Low Noise Block (LNB) Wireless Transverser 102 and a Set-Top-Box (STB) Wireless Transverser 104. The system may also include a satellite dish 106 and/or a television 108. The satellite dish 106 includes a feed horn 105 and other components such as the parabolic dish and a support stand. The television 108 may be an analog television, a monitor, high definition television (HDTV), or other type of analog or digital display device. The LNB Wireless Transverser 102 may also serve as a wireless Access Point (AP), which is provided to access network resources, via a distribution system such as the Internet (not shown herein, for purposes of simplicity, are the Ethernet switch, Internet gateway, WAN/LAN interface and local server), while the STB Wireless Transverser 104 may act as a client device in order to communicate with the LNB Wireless Transverser 102, via wireless transmission, as specified by IEEE 802.11(a), (b) and/or (g) standards for a wireless local area network. The wireless Access Point (AP) may serve a central connection that allows multiple client STB Wireless Transversers 104 to wirelessly connect to a network that is either created by the LNB Wireless Transverser;

102 serving as an Access Point or a client station without having dedicated cables, and communicate according to the IEEE 802.11(a), (b) and/or (g) standards for a wireless local area network (WLAN) or wireless virtual private network (WVPN).

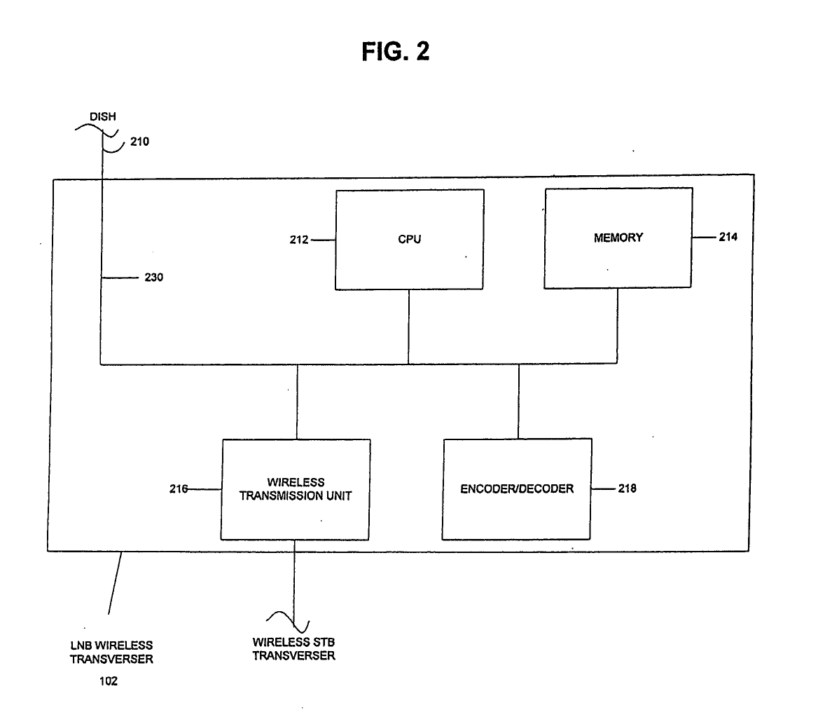

FIG. 2 illustrates an example Low Noise Block (LNB) Wireless Transverser according to an embodiment of the present invention. Referring to FIG. 2, the LNB Wireless Transverser 102 comprises a central processing unit (CPU) 212, a memory 214, a wireless transmission unit 216, an Encoder/Decoder 218 and a bus 230. The LNB Wireless Transverser 102 receives a signal from the satellite dish 106 on an input 210. The signal is received from a provider satellite distributing satellite programming via the Low Noise Block (LNB), typically located in the feed horn 105 of the satellite dish 106. The LNB resident in the satellite feed horn 105 amplifies the radio signals bouncing off the satellite dish 106 and filters out the noise (i.e., radio signals that are not carrying programming). The signal that was amplified and filtered is then sent to the LNB Wireless Transverser 102 via input 210.

The amplified and filtered signal is encoded, according to the Moving Picture Experts Group-2 (MPEG-2) standard, for example, by the Direct Broadcast Satellite (DBS) provider. The unencoded satellite signal comprising approximately 200 channels is approximately 270 Mbps. With MPEG-2 encoding the signal stream is approximately 10 Mbps. However, as more channels are added and HDTV becomes the standard for all programming the required bandwidth will increase. Also, the signal is often scrambled or encrypted in order for the provider to limit access to the programming to subscribers. The CPU 212 controls the LNB Wireless Transverser 102 to buffer the signal in the memory 214 and to decode and decrypt the signal with the Encoder/Decoder 218 as necessary. The DBS provider can communicate with the Encoder/Decoder 218 via the satellite signal in order to set or adjust the decoding algorithms. This may be done to periodically update the encryption scheme to frustrate illegal users or to set the level of service of the subscribing user to a different level.

The CPU 212 then selects individual channels from the decoded signal and packages them together and using the Encoder/Decoder 218 encodes the multiplexed channels using the MPEG-2 standard or other suitable compression method in order to efficiently utilize the available bandwidth. A multiplexer/demultiplexer arrangement may be utilized to configure the decoded signal via multiplexing the data corresponding to selected channels. The encoded multiplexed channels are transmitted along the bus 230 to the Wireless Transmission Unit 216 for transmission to the STB Wireless Transverser 104. The LNB Wireless Transverser 102 may also take the encoded signal received via an input 210, and route it directly to the Wireless Transmission Unit 216 for transmission to the STB Wireless Transverser 104. This may be done when it is determined that there is sufficient bandwidth to transmit the entire encoded signal or if the subscriber has a faster and high capacity connection that supports the approximately 10 Mbps encoded signal stream from the satellite. The bandwidth required depends on the encoding performed by the provider and may vary.

The memory 214 serves as a resource as needed by the CPU 212 and as temporary storage for the satellite signal, the decoded signal and/or the encoded signal to be transmitted by the Wireless Transmission Unit 216. The memory 214 may be any memory device, volatile or non-volatile, such as semiconductor, magnetic, optical or other memory device.

The Encoder/Decoder 218 during the encoding process analyzes each frame in the decoded multiplexed signal stream and decides how to encode the frame. Each frame is encoded according to the MPEG-2 standard in one of three ways; an intraframe, a predicted frame or a bidirectional frame. The intraframe contains the complete image data for that frame. Using intraframe provides the least amount of compression. The predicted frame includes enough information to inform the STB Wireless Transverser 104 how to display the frame based on the most recently displayed intraframe or predicted frame. Thus, the current frame being encoded includes only the data that relates to the changes that occurred from the most recently displayed frame to the current frame. The bidirectional frame is an interpolation of surrounding intraframes or predicted frames. The STB Wireless Transverser 104 will use data from the surrounding frames to interpolate the position and color of individual pixels for display. Because the LNB Wireless Transverser 102 is encoding only a portion of the whole signal received from the provider satellite very high quality, glitch free video images may be displayed on the television 108 over the wireless link. The selection of the portion of the decoded satellite signal which is encoded by the Encoder/Decoder 218 of the LNB Wireless Transverser 102 for wireless transmission to the STB Wireless Transverser 104 is controlled by the CPU 212. The selection may be according to the level of service that the subscriber is paying for. For example, a basic subscriber may only be entitled to view 50 of the 200 channels in the satellite signal. Thus, by decoding the satellite signal and packaging only the 50 channels available to that subscriber the amount of bandwidth required is substantially reduced. Also, the selection of the portion of the satellite signal may be based on identifying information received from the STB Wireless Transverser 104. The identifying information will be described more below with respect to the STB Wireless Transverser 104.

The Wireless Transmission Unit 216 includes a transmitter, a receiver and a processing circuitry (not shown) configured to transmit or receive wireless data and control streams and perform digital processing in accordance with IEEE 802.11(a), (b) and/or (g) standards for a wireless local area network (WLAN). Radio signals transmitted from the Wireless Transmission Unit 216 may be unidirectional or bidirectional in the wireless domain to comply with frequencies of the 2.4-5 GHz bands as dictated by 802.11(a), (b) and/or (g) standards. Such a Wireless Transmission Unit 216 may also be utilized through its modular hardware and software combination, to perform all necessary control and handshaking signals required. The transmitter/receiver may be an integrated component or separate components to perform transmission and reception functions. The Wireless Transmission Unit 216 interfaces with an antenna (not shown) to transmit and receive signals wirelessly via radio waves.

The LNB Wireless Transverser 102 components such as the CPU 212, the memory 214, the Wireless Transmission Unit 216 and the Encoder/Decoder 218 are illustrated as connected to a bus 230 for communication. However, it is understood that these components may be connected according to other methods such as direct wired.

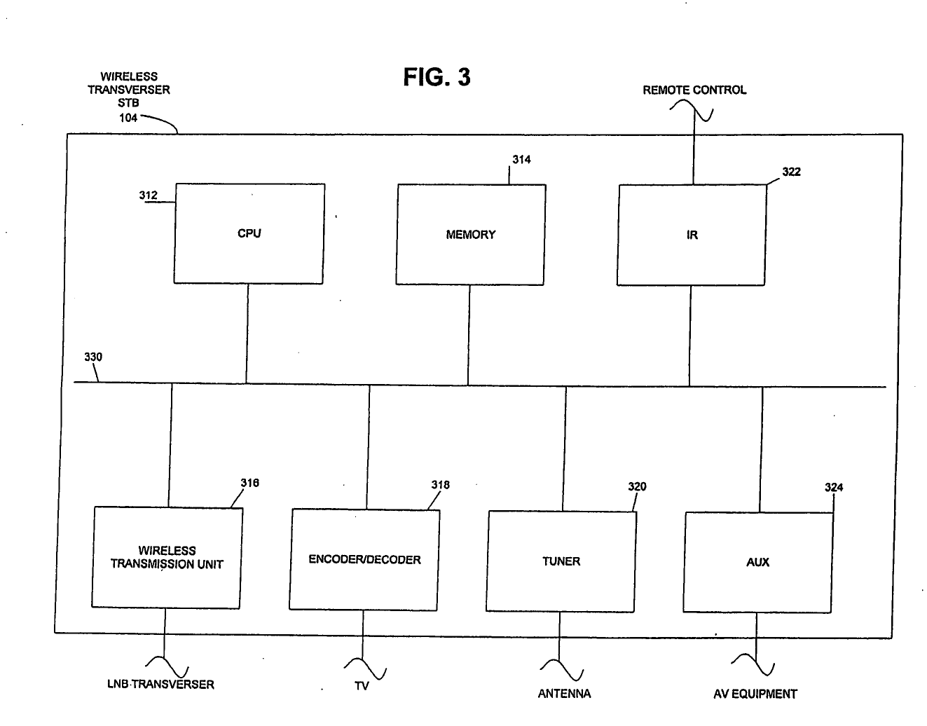

FIG. 3 illustrates an example Set-Top-Box (STB) Wireless Transverser according to an embodiment of the present invention. Referring to FIG. 3, the STB Wireless Transverser 104 comprises a central processing unit (CPU) 312, a memory 314, a wireless transmission unit 316, an Encoder/Decoder 318, a tuner 320, an infrared transmission unit 322, an auxiliary input unit 324 and a bus 330. The STB Wireless Transverser 104 receives an encoded signal from the the Low Noise Block (LNB) Wireless Transverser 102. The encoded signal is a stream comprising programming from the satellite provider. The encoded signal is received by the Wireless Transmission Unit 316 from the LNB Wireless Transverser 102.

The CPU 312 controls the STB Wireless Transverser 104 to buffer the encoded signal received by the Wireless Transmission Unit 316 in the memory 314 and to decode and decrypt the signal with the Encoder/Decoder 318 as necessary. The provider can communicate with the Encoder/Decoder 318 via the satellite signal transmitted by the LNB Wireless Transceiver 102 in order to set or adjust the decoding algorithms. The CPU 318 functions to control the flow of data within the STB Wireless Transverser 104 along the bus 330 to the appropriate component. As discussed above this may be done to periodically update the encryption scheme to frustrate illegal users or to set the level of service of the subscribing user to a different level.

The memory 314 serves as a resource as needed by the CPU 312 and as temporary storage for any signal or data streams such as those processed and transmitted by the STB Wireless Transverser 104. The memory 314 also serves as a buffer for the encoded selected satellite signal stream received from the LNB Wireless Transverser 102. The memory 314 may be any memory device, volatile or non-volatile, such as semiconductor, magnetic, optical or other memory device.

The Wireless Transmission Unit 316 includes a transmitter, a receiver and a processing circuitry (not shown) configured to transmit or receive wireless data and control streams and perform digital processing in accordance with IEEE 802.11(a), (b) and/or (g) standards for a wireless local area network (WLAN). Radio signals transmitted from the Wireless Transmission Unit 216 may be uni-directional or bidirectional in the wireless domain to comply with frequencies of the 2.4-5 GHz bands as dictated by 802.11(a), (b) and/or (g) standards. Such a Wireless Transmission Unit 316 may also be utilized through a modular hardware and software combination, to perform all necessary control and handshaking signals required. The transmitter/receiver may be an integrated component or separate components to perform transmission and reception functions. The Wireless Transmission Unit 316 interfaces with an antenna (not shown) to transmit and receive signals wirelessly via radio waves.

The Encoder/Decoder 318 decodes the encoded signal received from the LNB Wireless Transverser 102 in accordance with the MPEG-2 standard. The Encoder/Decoder 318 takes the digital MPEG-2 signal and converts it into an analog format that a standard television or monitor can recognize. For example, in the United States the Encoder/Decoder 318 would convert the digital signal to the analog National Television System Communication (NTSC) format. Other formats such as sequential colour with memory (SECAM), phase alternating line (PAL) and high definition television (HDTV) may also be used. If the encoded signal includes more than one channel then the Encoder/Decoder 318 extracts individual channels (e.g., CNN, ABC, etc.) from the larger signal. The STB Wireless Transverser 104 sends one selected channel to the television 108 for display according to control of the CPU 318 via the Encoder/Decoder 318.

The Encoder/Decoder 318 also processes signals received via the tuner 320 and the auxiliary input 324. The tuner 320 is configured to receive signal inputs from a variety of sources such as a VHF antenna and/or UHF antenna. The signals received by the tuner 320 are directed under the control of the CPU 312 to the Encoder/Decoder 318 for output to the television 108. The auxiliary input 324 includes at least one input for receiving signals from other audio/visual entertainment components such as DVDs, CDs and VCRs. The signals received are then directed to the television 108 for audio and/or video output.

The Encoder/Decoder 318 also packages the encoded signals from the LNB Wireless Transverser 102, tuner 320 or the auxiliary input 324 for further transmission. The transmission of the tuner and auxiliary input signals may occur when the STB Wireless Transverser 104 is operating in an Ad-hoc mode, which will be described below with respect to FIG. 5.

The infrared transmission unit 322 receives data corresponding to commands and input settings from a standard infrared remote control used with a television. When a subscriber selects a channel (e.g., CNN) with the remote the CPU 312 receives and executes a program in response to the input received via the infrared transmission unit 322. The CPU 312 utilizes the other components of the STB Wireless Transverser 104 to execute the program corresponding to the subscriber input. For example, the CPU 312 would cause the Encoder/Decoder 318 to encode data comprising a command instructing the LNB Wireless Transverser 102 to transmit the programming data for CNN to the STB Wireless Transverser 104. The CPU 312 would then control the Wireless Transmission Unit 316 to transmit the encoded command to the LNB Wireless Transverser 102.

In this manner, the LNB Wireless Transverser 102 receives the identifying information necessary to determine the programming data corresponding to selected channels to transmit to the STB Wireless Transverser 104. The LNB Wireless Transverser 102 can be configured to multiplex and compress a portion of the programming data corresponding to a predetermined number of channels in the same category as the selected channel (e.g. other news channels or movie channels) or that are numerically within a given range of the selected channel (e.g. channels 15-25 when channel 20 is selected). In this mode of operation Wireless Satellite Transverser System 100 can manage the bandwidth required for wireless transmission to ensure a high quality picture. The bandwidth can depend on which version of the IEEE 802.11 standard is being used and on other conditions affecting the available bandwidth such as distance between the LNB Wireless Transverser 102 and the STB Wireless Transverser 104.

The LNB Wireless Transverser 102 can also be configured to transmit all the programming data to the STB Wireless Transverser 104, in which case the CPU 312 causes the Encoder/Decoder 318 to output the selected channel to the television 108 without interacting with the LNB Wireless Transverser 102.

The Wireless Satellite Transverser System 100 works in both wireless Infrastructure. and Ad-hoc modes to communicate with the satellite dish and with similar wireless satellite transversers connecting to the same dish or multiple dishes in a Wireless Local Area Network (WLAN) or Wireless Virtual Private Network (WVPN).

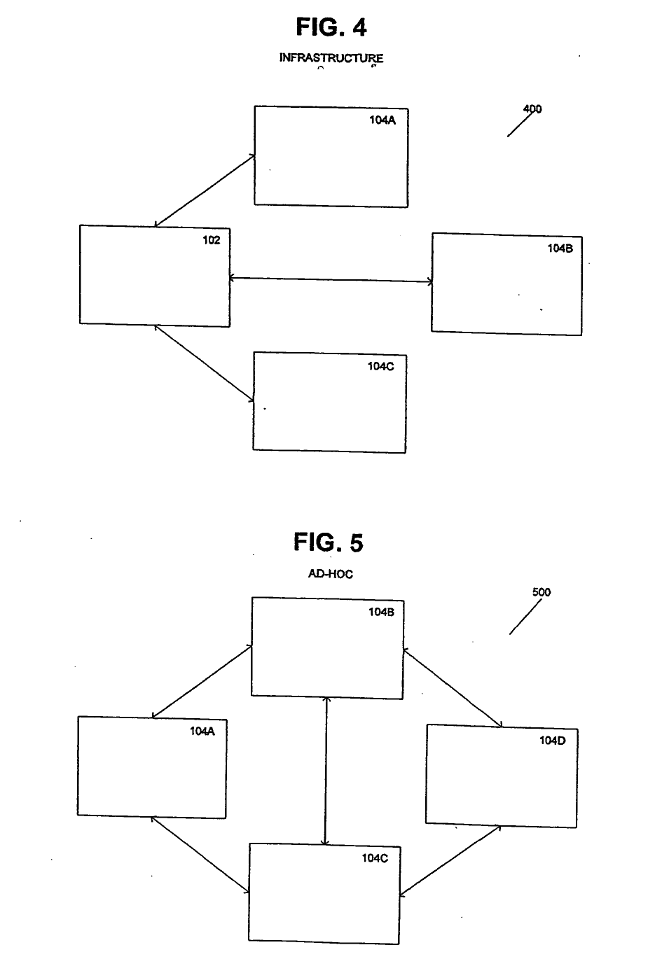

FIG. 4 illustrates an example interaction between the LNB Wireless Transverser and STB Wireless Transversers in an Infrastructure mode according to an embodiment of the present invention. A wireless access point (AP) is required for Infrastructure mode wireless networking. APs are wireless networking devices that allow one or more wireless clients to use the device as a central hub, When using an access point, all clients communicate through the access point. Multiple access points are often used to cover a complete area such as a house, office building or warehouse with a wireless network. The IEEE 802.11(a), (b) and/or (g) standard defines the protocol that wireless networks use to connect. To join the WLAN, the AP and all wireless clients must be configured to use the same Service Set Identifier (SSID). A wireless client can also attach to any network by not explicitly setting the SSID. The AP is then cabled to a wired network or other data source to allow the wireless clients access to, for example, Internet connections, printers, and in the embodiment illustrated in FIG. 4, satellite programming. Additional APs can be added to the WLAN to increase the reach of the Infrastructure and support any number of wireless clients.

Referring to FIG. 4, the Wireless Satellite Transverser System 400 comprises at least one LNB Wireless Transverser 102 and a plurality of STB Wireless Transversers 104A-104C. The LNB Wireless Transverser 102 functions as a wireless Access Point (AP) communicating with the plurality of STB Wireless Transversers 104 each of which is functioning as a wireless client device. Assuming that the STB Wireless Transverser 104A-104C is configured to operate in Infrastructure mode, the Wireless Transmission Unit 316 chooses the LNB Wireless Transverser 102 with which to connect. This selection is made automatically by using an SSID and signal strength and frame error rate information. Next, the Wireless Transmission Unit 316 establishes association by switching to the assigned channel of the selected LNB Wireless Transverser 102 and negotiates the use of a port.

If the signal strength of the LNB Wireless Transverser 102 is too low, the error rate too high, or if instructed by the operating system of the CPU 312, the Wireless Transmission Unit 316 scans for other LNB Wireless Transversers (not shown) to determine whether a different LNB Wireless Transverser can provide a stronger signal or lower error rate. If such a LNB Wireless Transverser is located, the Wireless Transmission Unit 316 switches to the channel of that wireless AP and negotiates the use of a port.

When each of the STB Wireless Transversers 104A-104C is in the Infrastructure mode of operation, the LNB Wireless Transverser 102 can transmit identical programming that it receives from the satellite provider to each of the STB Wireless Transversers 104A-104C. Because the LNB Wireless Transverser 102 decodes the satellite programming prior to wirelessly transmitting to the STB Wireless Transverser 104, it can also selectively multiplex and encode different data corresponding to different groups of channels to each of the STB Wireless Transversers 104A-104C in the WLAN. The data streams of different groups of individual channels may be multiplexed and the resultant combined stream is transmitted from the low noise block wireless transverser 102 to a STB wireless transverser 104A-104C. The multiplexed stream will be de-multiplexed at each of the STB wireless transversers 104A-104C. For example, in a Wireless Satellite Transverser System 400 set up in a house if a first user wants to watch CNN on a first television coupled with the first STB Wireless Transverser 104A and a second user wants to watch ESPN on a second television coupled with the second STB Wireless Transverser 104B, then each will transmit a command to the LNB Wireless Transverser 102 indicating which channels have been selected by the respective first and second users. The LNB Wireless Transverser 102 receives the commands via the Wireless Transmission Unit 216 and under the control of the CPU 212, the Encoder/Decoder 218 will take the decoded satellite programming signal and will demultiplex the pertinent signals corresponding to the selected channels and will then encode the pertinent signals and transmit them back to the respective STB Wireless Transversers 104A and 104B. The Encoder/Decoder 218 using MPEG-2 compression according to this method of operation can create smaller data streams for each STB Wireless Transverser 104A-104C. In this way the available bandwidth is not a problem and the signals provide high quality images.

FIG. 5 illustrates an example interaction between STB Wireless Transversers in an Ad-hoc mode according to an embodiment of the present invention. In Ad-hoc mode, also known as peer-to-peer mode, wireless clients communicate directly with each other (i.e., without the use of a wireless AP). Two or more wireless clients who communicate using Ad-hoc mode form an Independent Basic Service Set (IBSS). Ad-hoc mode is used to connect wireless clients when a wireless AP is not present or when a different mode of operation is desired. Generally, algorithms such as the spokesman election algorithm (SEA) operate to elect one wireless client as the “master” of the WVPN and the other wireless client devices operate as “slaves.” Another type of method used in Ad-hoc networks relies on broadcasts and replies. In this approach the client devices all broadcast identifying information to establish communication links with other client devices within range and on the same network.

Referring to FIG. 5, this mode is a method for wireless devices such as the STB Wireless Transversers 104A-104D in the Wireless Transverser System 500 to directly communicate with each other. Operating in Ad-hoc mode allows the STB Wireless Transversers 104A-104D within range of each other to discover and communicate in peer-to-peer fashion without involving central access points. To set up an Ad-hoc wireless network, each Wireless Transmission Unit 316 must be configured for Ad-hoc mode versus the alternative Infrastructure mode. In addition, all Wireless Transmission Units 316 on the Ad-hoc network must use the same SSID and the same channel number. An Ad-hoc network tends to feature a small group of devices all in very close proximity to each other such as in a house. However with the advent of new wireless communication standards such as Wi-MAX the range will be increased dramatically and it will be practical for a group of devices in a much larger area such as a large office building.

Ad-hoc networks cannot bridge to wired LANs (i.e., the LNB Wireless Transverser 102) or to the Internet without installing a special-purpose gateway. A network gateway is an internetworking system that joins two networks together. The network gateway can be implemented completely in software, completely in hardware, or as a combination of the two. Referring to FIG. 3, the network gateway necessary for interface with the LNB Wireless Transverser 102 can be implemented in the CPU 312 in software.

When a user selects the Ad-hoc mode of operation, either through a button selection or via a remote control, the Wireless Transmission Unit 316 begins to scan across the wireless frequencies for wireless APs (i.e., the LNB Wireless Transverser 102) and/or other wireless clients (i.e., other STB Wireless Transversers 104A-104D) in Ad-hoc mode. In this mode of operation a first STB Wireless Transverser 104A can distribute a data stream to at least one of the remaining STB Wireless Transversers 104B-104D for display on corresponding respective televisions. The data stream distributed can be a DVD movie that is being played on a first television via the first STB Wireless Transverser 104A. Thus, a subscriber could play a DVD in one room and let televisions in other rooms view the same program. This can be very useful in an office environment so that a large group could be split up into smaller available rooms for display.

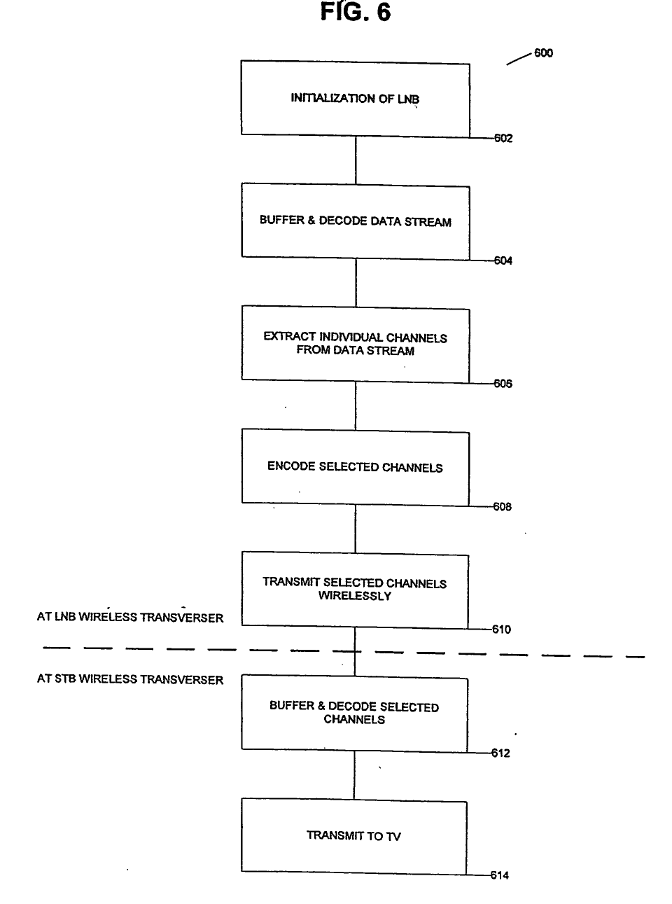

FIG. 6 is a flow diagram of an example process of generating and transmitting programming wirelessly from a satellite dish to a television according to an embodiment of the present invention. The satellite dish 106 receives the satellite programming data stream and the low noise block in the feed horn filters and amplifies the data stream prior to transmitting the amplified and filtered data stream to the LNB Wireless Transverser 102. The Wireless Satellite Transverser System 100 is assumed to be operating in the Infrastructure mode in this example. In operation 602 the LNB Wireless Transverser 102 is initialized with default settings set up by a manufacturer or the direct broadcast satellite provider or by receiving identifying information from the STB Wireless Transverser 104. The identifying information corresponds to a command input from a user. For example, when the user turns on the system and selects channel 7 with a remote, the STB Wireless Transverser 104 encodes and transmits this selection as identifying information to the LNB Wireless Transverser 102 via the wireless communication link operating in the Infrastructure mode. In operation 604, the LNB Wireless Transverser 102 buffers the data stream in the memory 214 and decodes the data stream with the Encoder/Decoder 218.

In operation 606, the LNB Wireless Transverser 102 Encoder/Decoder 218 extracts programming data corresponding to individual channels from the decoded data stream by demultiplexing the data stream. The extracted programming data corresponds to the user selection indicated in the identifying information. The extracted programming data corresponding to channel 7 is then encoded by the Encoder/Decoder 218 in operation 608. The CPU 212 then controls the Wireless Transmission Unit 216 to transmit the encoded programming data to the STB Wireless Transverser 104.

The STB Wireless Transverser 104 buffers the encoded data stream in the memory 314 and decodes the data stream with the Encoder/Decoder 318 under the control of the CPU 312. The Encoder/Decoder 318 decodes the data stream according to the MPEG-2 standard and formats the decoded data stream for display on the television 108. The formatted data stream is then output to the television 108 in operation 614.

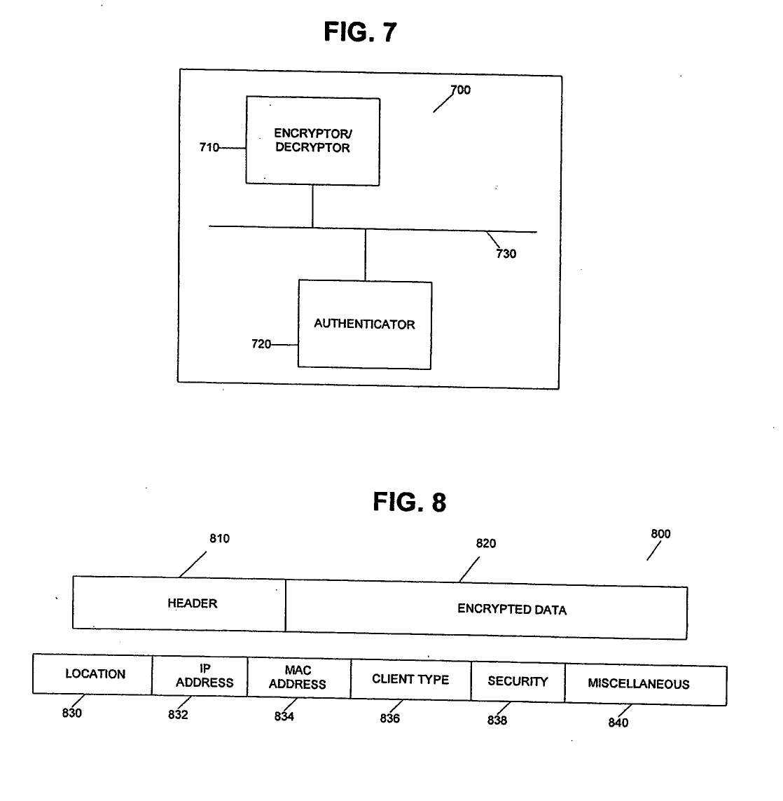

FIG. 7 illustrates an example circuit diagram of a Wireless Transverser according to another embodiment of the present invention. As shown in FIG. 7, the Wireless Transverser 700 may also be provided with an encryptor/decryptor 710 and an authenticator 720 for wireless security protection and authentication interfacing with a bus 730. The Wireless Transverser 700 illustrated is generic for both the LNB Wireless Transverser 102 and the STB Wireless Transverser 104 in the Wireless Satellite Transverser System 100 because both may utilize the encryptor/decryptor 710 for enhanced security. The encryptor/decryptor 710 can be a firmware component that encrypts data transmitted wirelessly according to the “Wired Equivalent Privacy” (WEP) where a WEP flag in the header of the transmitted packet is inserted. In addition, an Integrity Check Value (ICV) may also be inserted in the encrypted portion of the wireless packet transmitted. Similarly, the authenticator 720 can also be a firmware component that authenticates the client instrument to associate with the controller using Wi-Fi Protection Access (WPA) or the second generation Wi-Fi Protection Access (WPA2) along with the Advanced Encryption Standard (AES). Two improved encryption algorithms may be used along with WPA to improve security of the data transmissions. These algorithms include the Temporary Key Integrity protocol (TKIP), or the CBC-MAC protocol (CCMP). The encryptor/decryptor 710 and the authenticator 720 can be implemented separately from each other and the other components of the Wireless Transversers 102 and 104 or they may be implemented in combination with another component, for example, the decoder/encoder 218 and 318.

In use, different modes of security protection and authentication may be used depending on the type of transmission. For example, when transmitting commands from the STB Wireless Transverser 104 to the LNB Wireless Transverser 102 an “open” mode of security may be used because commands such as changing a channel in order to surf the channels available do not need protection. However, for other modes of operation, such as the transmission of the satellite signal should be encrypted at least using the WEP encryption to minimize unauthorized reception.

In addition, a separate firmware component can also be implemented to add wireless Multimedia (WMM) differentiated service capability to the transmitted streams. In this way data streams of time-critical applications may be prioritized higher than all other types of data or control and management streams. This approach also permits users that pay for a premium service may be given better quality streams than someone paying for a standard service.

FIG. 8 illustrates an example data packet including provisions for wireless security protection and authentication. As shown in FIG. 8, each data packet 800 contains a header 810 and a data payload 820. The header 810 comprises a plurality of fields, including, for example, a location field 830, an IP address field 832, a medium access control (MAC) address field 834, a client device type field 836, a security field 838, and other miscellaneous provisions 840. The location field 830 may be used to describe the location of the STB Wireless Transverser 104A serving as the access point as shown in FIG. 4. In the case of the Infrastructure mode the location field 830 may be used to identify the location of the LNB Wireless Transverser 102 as shown in FIG. 4. The IP address field 832 may include the unique IP address of the wireless clients (i.e., STB Wireless Transversers 104A-104C) and the AP (i.e., LNB Wireless Transverser 102), while the MAC address 834 may contain the unique MAC address of the access point (LNB Wireless Transverser 102, shown in FIG. 4). Field 836 may contain the number of clients coupled with the access point and define the client type, for example, such as the IEEE 802.11(a) transverser, IEEE 802.11(b) transverser, or IEEE 802.11(g) transverser. The security field 838 may illustratively include 64-bit or 128-bit wireless equivalent privacy (WEP) keys under the 802.11x standard, which can be used in the network of the LNB Wireless Transverser 102 and STB Wireless Transversers 104A-104C, or any other private keys that allow communication with each LNB Wireless Transverser (102) (i.e., the AP). Other miscellaneous fields 840 may include, for example, quality of service information, and the like, as required. For example, a request for services may include various grades of quality-of-service (QoS) information. The grades of service are quality of service levels, which may include constant bit rate (CBR), variable bit rate (VBR), real-time variable bit rate (VBR-RT), controlled load, guarantee service, best effort services, among other services known in the industry. In one embodiment, best effort level of service may be a default level of service. However, in those instances where a user requires requested information without delay or artifacts that may occur when using best effort level of service, the user may request a guaranteed service level, which provides dedicated bandwidth to provide the requested information. In this way subscriber levels can be easily modified.

Various components of the Wireless Satellite Transverser System as shown, for example, in FIG. 4, can be implemented in hardware, such as, for example, an application specific integrated circuit (ASIC). As such, it is intended that the processes described herein be broadly interpreted as being equivalently performed by software, hardware, or a combination thereof. Software modules can be written, via a variety of software languages, including C, C++, Java, Visual Basic, and many others. The various software modules may also be integrated in a single application executed on various types of processors. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the PC cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over satellites, telephone lines, network lines, wireless links, cables, and the like) may communicate the code segments, including instructions, to the network node or element. Such carrier waves may be in the form of electrical, optical, acoustical, electromagnetic, or other types of signals.

As described from the foregoing, the present invention advantageously provides the user with improved mobility through wireless interface techniques and means installed in the satellite receiver (i.e., LNB Wireless Transverser) and different types of reception devices (i.e., set top box) in computer controlled direct broadcast satellite television systems to comply with wireless transmission needs as required by the IEEE 802.11(a), (b) and/or (g) standards for a wireless local area network for wireless distribution of satellite signals to various areas within a building. The Wireless Satellite Transverser System is provided to permit flexible locations within a building for watching television, which is provided with a signal via direct broadcast satellite.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the components of the LNB Wireless Transverser and the STB Wireless Transverser can each be separately implemented in a single hardware or firmware installed at an existing IEEE interface module to perform the functions as described. In addition, the wireless network has been described in the context of a telecommunications network having an architecture typical of North America, it should be appreciated that the present invention is not limited to this particular wireless network or protocol. Rather, the invention is applicable to other wireless networks and compatible communication protocols. Furthermore, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Accordingly, it is intended, therefore, that the present invention not be limited to the various example embodiments disclosed, but that the present invention includes all embodiments falling within the scope of the appended claims.

What is claimed is:

1. A satellite television entertainment system, comprising:
a satellite dish to receive satellite television programming data;
at least one first wireless transverser to wirelessly receive the satellite television programming data and format the satellite television programming data for display on a television; and
a second wireless transverser coupled with the satellite dish to wirelessly transmit the satellite television programming to the at least one first wireless transverser.

2. The satellite television entertainment system of claim 1, wherein the second wireless transverser configures data streams of different groups of individual channels from among all channels corresponding to the satellite television programming data such that each of the data streams of the different groups are wirelessly transmitted to a different one of the at least one first wireless transverser.

3. The satellite television entertainment system of claim 1, wherein the second wireless transverser multiplexes data streams of different groups of individual channels corresponding to the satellite television programming data and transmits, according to wireless transmission standards specified by IEEE 802.11(a), (b) and/or (g), the multiplexed stream to the at least one first wireless transverser which de-multiplexes the multiplexed stream into the data streams.

4. The satellite television entertainment system of claim 1, wherein the at least one first wireless transverser comprises:
an encoder/decoder configured to format the satellite television programming data into individual channels suitable for display on the television; and
a wireless transmission unit configured to wirelessly transmit and receive data streams including the satellite television programming data.

5. The satellite television entertainment system of claim 4, wherein the at least one first wireless transverser further comprises:
a tuner to receive broadcast signals from a VHF and/or UHF antenna, wherein the encoder/decoder formats the broadcast signals for display on the television.

6. The satellite television entertainment system of claim 5, wherein the encoder/decoder encodes the satellite television programming data and/or the broadcast signals for wireless transmission to another first wireless transverser.

7. The satellite television entertainment system of claim 4, wherein the at least one first wireless transverser comprises:
an auxiliary audiovisual (AV) equipment interface to receive AV signals from audio/visual equipment, wherein the encoder/decoder formats the broadcast signals for display on the television and/or for audio reproduction via speakers coupled with the television.

8. The satellite television entertainment system of claim 7, wherein the encoder/decoder encodes the satellite television programming data and/or the AV signals for wireless transmission to another first wireless transverser.

9. The satellite television entertainment system of claim 1, wherein the second wireless transverser comprises:
an encoder/decoder configured to decode the satellite television programming data received via the satellite dish and selectively package a group of individual channels from among all channels corresponding to the satellite television programming data; and
a wireless transmission unit configured to wirelessly transmit and receive data streams, wherein the selectively packaged group of individual channels is encoded by the encoder/decoder for wireless transmission to the at least one first wireless transverser.

10. The satellite television entertainment system of claim 9, wherein the encoder/decoder of the second wireless transverser configures different groups of individual channels from among all the channels such that each of the different groups are wirelessly transmitted to a different ones of the at least one first wireless transverser.

11. A system, comprising:
a plurality of wireless transverser clients to wirelessly receive broadcast data corresponding to a selected set of television channels and format the programming data for display on a television; and
at least one low noise block wireless transverser to receive satellite programming data and to serve as an access point for a wireless network distribute the broadcast data to the plurality of wireless transverser clients, wherein the at least one low noise block wireless transverser decodes the satellite programming data and selects and compresses the broadcast data from the satellite programming data for distribution.

12. The system of claim 11, wherein the at least one low noise block wireless transverser comprises:
an encoder/decoder configured to decode the satellite programming data and multiplex the broadcast data; and
a wireless transmission unit configured to wirelessly transmit and receive data streams including the broadcast data, wherein the broadcast data is compressed by the encoder/decoder for wireless transmission to the plurality of wireless transverser clients.

13. The system of claim 12, wherein the encoder/decoder of the low noise block wireless transverser selects and compresses different sets of the satellite programming data such that each of the different sets are wirelessly transmitted to a different one of the plurality of wireless transverser clients.

14. The system of claim 11, wherein the at least one low noise block wireless transverser serves as a wireless access point and each of the plurality of wireless transverser clients serve as a client device communicating with the at least one low noise block wireless transverser according to wireless transmission standards specified by IEEE 802.11(a), (b) and/or (g).

15. The system of claim 11, wherein one of the plurality of wireless transverser clients encodes the broadcast data and/or other signals for wireless transmission to at least one other of the wireless transverser clients.

16. The system of claim 15, wherein each of the plurality of wireless transverser clients sends a command to the low noise block wireless transverser to indicate the broadcast data to be selected from the satellite programming data.

17. The system of claim 16, wherein the low noise block wireless transverser selects and compresses different sets of the satellite programming data corresponding to the respective command.

18. A wireless satellite distribution device, comprising:
a memory;
a processor coupled with the memory;
an encoder/decoder controlled by the processor to decode satellite programming data, buffered in the memory, and selectively compress a portion of the satellite programming data for distribution; and
a wireless transmission unit configured to wirelessly distribute the portion of the satellite programming data according to control of the processor.

19. The wireless satellite distribution device according to claim 18, wherein the wireless distribution device serves as a wireless access point communicates with a plurality of wireless client devices according to wireless transmission standards specified by IEEE 802.11(a), (b) and/or (g).

20. The wireless satellite distribution device according to claim 18, further comprising:
an encryptor/decryptor to encrypt the portion of the satellite programming data for distribution according to the wired equivalent privacy protocol and decrypt all received data; and
an authenticator to authenticate the received data using Wi-Fi Protection Access or Wi-Fi Protection Access 2 along with Advanced Encryption Standard protocol.
